(19) United States
(12) Patent Application Publication
(10) Pub. No.: US 2025/0382437 A1
(43) Pub. Date: Dec. 18, 2025

(54) COMPOSITION COMPRISING CATIONIC AND ANIONIC POLYELECTROLYTES AND BORON NITRIDE PARTICLES

(71) Applicant: SAINT-GOBAIN CERAMICS & PLASTICS, INC., Worcester, MA (US)

(72) Inventors: Hua WANG, Northbridge, MA (US); Francisco Javier CEDANO SERRANO, Speyer (DE); Nicholas James WATKINS, Natick, MA (US); Cassandra T. TUBBS, Boylston, MA (US)

(21) Appl. No.: 19/240,902

(22) Filed: Jun. 17, 2025

Related U.S. Application Data
(60) Provisional application No. 63/661,291, filed on Jun. 18, 2024.

(51) Int. Cl. C08K 3/38; C08F 220/06; C08G 73/02; C09D 7/61

(52) U.S. Cl. CPC C08K 3/38; C08F 220/06; C08G 73/0206; C09D 7/61; C08K 2003/385; C08K 2201/001; C08K 2201/005; C08K 2201/013

(57) ABSTRACT

A composition can comprise a cationic polyelectrolyte, an anionic polyelectrolyte, boron nitride particles, a polymer having a glass transition temperature of lower than 50° C.; and water, wherein an amount of the boron nitride particles is at least 55 wt % based on a total dry weight of the composition. The composition can be used in a process of forming a coating, wherein the coating may contain boron nitride particles of up to 90 wt % and have a thermal conductivity of up to greater than 30 W/mK.

### CROSS-REFERENCE TO RELATED APPLICATION(S)

This application claims priority under 35 U.S.C. § 119(e) to U.S. Patent Application No. 63/661,291, entitled “COMPOSITION COMPRISING POLYELECTROLYTE COACERVATES AND BORON NITRIDE PARTICLES,” by Hua WANG et al., filed Jun. 18, 2024, which is assigned to the current assignee hereof and incorporated herein by reference in its entirety.

### FIELD OF THE DISCLOSURE

The present disclosure relates to a composition comprising a cationic polyelectrolyte, an anionic polyelectrolyte, boron nitride particles, and water. The present disclosure further relates to a process of manufacturing a coating from the composition, and an article comprising the coating.

### BACKGROUND

Thermally conductive composite materials are widely used in the thermal management of electric vehicle batteries, electronic devices, telecommunication equipment, and LED lamps to ensure efficient heat dissipation. With the ever-increasing power density of electronic devices and telecommunication equipment, thermal management materials that are highly heat conductive are becoming more important. One approach to achieving materials with high thermal conductivities is to add thermally conductive fillers such as boron nitride, alumina nitride, alumina, magnesium oxide, and silicon carbide to a polymeric binder to boost the intrinsic thermal conductivity of the obtained polymer composites. More particularly, hexagonal boron nitride, which is an anisotropic ceramic material, is promising for these applications because it is both highly thermally conductive and electrically insulating.

However, making polymer compositions loaded with high concentrations of such conductive fillers is difficult because high concentrations cause a large increase in viscosity that makes the polymer composition difficult to apply. Also, if dilutants, such as water, are added, the polymer compositions tend to phase-separate and become unstable. Moreover, the most difficult issue remains to maintain the polymer composition as a homogeneous liquid, with no settling of the conductive fillers.

There exists a need of developing improved compositions comprising boron nitride which may solve said problems.

### BRIEF DESCRIPTION OF THE DRAWINGS

The present disclosure may be better understood, and its numerous features and advantages made apparent to those skilled in the art by referencing the accompanying drawings.

FIG. 1A includes a line drawing illustrating a platelet type hBN particle according to one embodiment.

FIG. 1B includes a line drawing illustrating a side view of a cross-cut of a coating having in-plane oriented hBN particles according to one embodiment.

FIG. 2 includes a graph illustrating the viscosities at different shear rates for compositions S1 and S2 and comparative composition C1 according to embodiments.

Skilled artisans appreciate that elements in the figures are illustrated for simplicity and clarity and have not necessarily been drawn to scale. For example, the dimensions of some of the elements in the figures may be exaggerated relative to other elements to help improve understanding of embodiments of the invention.

### DETAILED DESCRIPTION

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

The present disclosure is directed to a composition comprising a cationic polyelectrolyte, an anionic polyelectrolyte, boron nitride (BN) particles, a polymer having a glass transition temperature of lower than 50° C., and water, wherein the amount of the boron nitride particles can be at least 55 wt % based on the dry weight of the composition.

It was observed that high concentrations of boron nitride particles can be introduced in an aqueous polyelectrolyte composition to form a homogeneous composition without causing a large increase in viscosity and without settling of the boron nitride particles over a time period of one month. The composition can be adapted to forming a coating having excellent properties for thermal management applications.

As used herein, the amounts of the ingredients of the composition of the present disclosure are expressed in two different ways: 1) in weight % based on the total weight of the composition, and 2) in weight % based on the total dry weight of the composition. In certain aspects, the weight % amount of an ingredient based on the total dry weight of the composition is interchangeable used to describe the amount of said ingredient (e.g., the BN particles) in the formed coating of the composition (after drying).

It is known that when an aqueous solution of an anionic polyelectrolyte and an aqueous solution of a cationic polyelectrolyte are mixed together at a pH where the anionic polyelectrolyte has a negative net charge and the cationic polyelectrolyte has a positive net charge, the polyelectrolytes may associate and form a solid complex (polyelectrolyte complex) that will separate from the aqueous phase. When the aqueous polymer solutions contain water-soluble mineral salts in a sufficient amount to at least partially screen the opposite charges of the polymers, the attraction between the polyanion and polycation can be reduced and formation of a solid complex be prevented. Upon mixing of such polyelectrolyte solutions, phase separation can be observed, which contain, on the one hand a concentrated polymer-rich phase, called “coacervate,” and, on the other hand, a polymer-depleted supernatant phase. A detailed description of this phenomenon can be found for example in Wang et al, “The Polyelectrolyte Complex/Coacervate Continuum,” Macromolecules, 2014, 47, 3108-3116. Such coacervate state can alternatively be obtained when the pH of the mixture is such that at least one of the anionic polyelectrolyte and the cationic polyelectrolyte has a zero net charge. In such case, there is no need to add salts to partially screen the charges.

As used herein, the term “cationic polyelectrolyte” encompasses one cationic polyelectrolyte but also mixtures of two or more different types of cationic polyelectrolytes. The term “anionic polyelectrolyte” encompasses one anionic polyelectrolyte, but also mixtures of two or more different anionic polyelectrolytes.

As used herein, the term “polymer having a glass transition temperature of lower than 50° C.” is interchangeable called “low glass transition temperature polymer,” if not indicated otherwise.

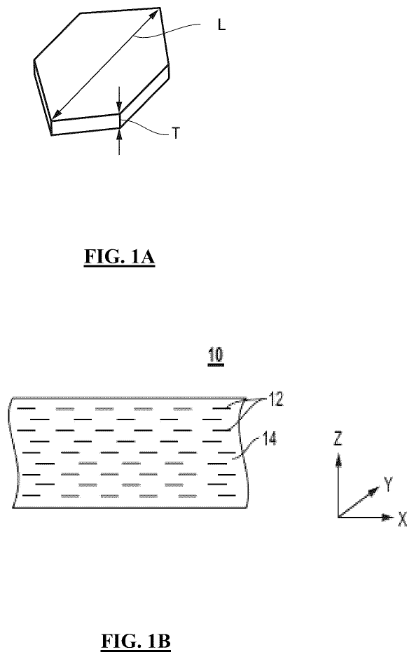

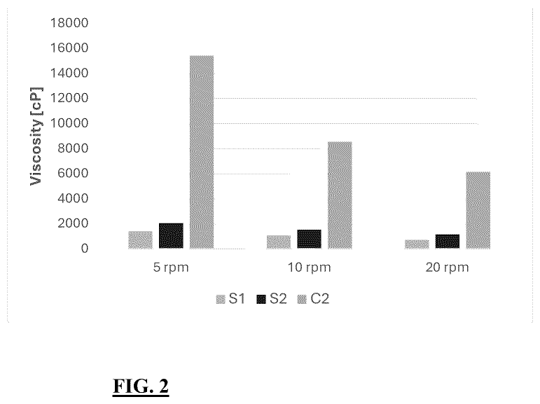

As used herein, the term “boron nitride particles,” if not indicated otherwise, relates to platelet shaped boron nitride particles having an average aspect ratio of length to thickness (L/T) of at least 5, as illustrated in FIG. 1A.

As further used herein, the term “in-plane” relates to the x-y direction of the coating formed from the composition of the present disclosure. FIG. 1B illustrates the cross-cut (10) of a coating wherein the BN particles (12) are distributed throughout a polymer matrix (14) and the BN particles (12) are oriented in the x-y direction of the coating, which is interchangeable called herein “in-plane.”

In one embodiment, the composition of the present disclosure can comprise a ratio of the number of positive charges of the cationic polyelectrolyte to the number of the negative charges of the anionic polyelectrolyte between 0.5 and 2.0, preferably between 0.6 and 1.8, more preferably between 0.7 and 1.6 and still more preferably between 0.8 and 1.4, or even between 0.9 and 1.2.

The polyelectrolytes may be strong or weak polyelectrolytes. A strong polyelectrolyte is a polymer having a positive or negative net charge that is essentially independent of the pH of the composition. In particular, the zeta potential of a strong cationic polyelectrolyte is positive for any pH in the range from 1 to 14 and the zeta potential of a strong anionic polyelectrolyte is negative for any pH in the range from 1 to 14. The zeta potential can be measured using a zeta potential analyzer (e.g., “zetasizer” device) at a suitable concentration (generally greater than 0.01%, for example 1% by weight of polyelectrolyte relative to the volume of solution analyzed) and generally at 20° C.

On the contrary, a weak polyelectrolyte is a polymer having a positive or negative net charge which is dependent on the pH. Typically, the zeta potential of a weak polyelectrolyte measured at pH 1 and the one measured at pH 14 are different by at least 10%. Usually, a weak polyelectrolyte has an isoelectric point (pI) between 1 and 14. Typically, a weak cationic polyelectrolyte usually has a pI higher than 7, for instance between 7.5 and 14, and a weak anionic polyelectrolyte usually has a pI lower than 7, for instance between 1 and 6.5. In the present application, isoelectric points are determined in water, at a temperature of 25° C. and at 0.01 M of NaCl.

Strong cationic polyelectrolytes are for example polymers comprising a plurality of quaternized amine groups; strong anionic polyelectrolytes are for example polymers comprising a plurality of sulfonate (—SO₃⁻ groups). Poly(acrylic acid) is an example of a weak anionic polyelectrolyte and non-quaternized polyamines are examples of weak cationic polyelectrolytes.

In the present disclosure, an anionic polyelectrolyte is a polymer with a negative net charge at pH 7 and a cationic polyelectrolyte is a polymer with a positive net charge at pH 7. This does not mean that an anionic polyelectrolyte comprises only negative charges and is free of positive charges. By analogy, cationic polyelectrolytes may comprise both cationic and anionic charges as long as, at pH 7, the overall net charge is positive.

Consequently, the definition of anionic polyelectrolytes encompasses zwitterionic polyelectrolytes having an isoelectric point (pI)<7, preferably <6, and the definition of cationic polyelectrolytes encompasses zwitterionic polyelectrolytes having an isoelectric point (pI)>7, preferably >8. The most commonly known zwitterionic polyelectrolytes are proteins or peptides comprising both pending carboxyl groups (—COOH) and pending amino groups (—NH₂).

In a certain embodiment, the anionic polyelectrolyte can comprise only negative charges and is free of positive charges, and the cationic polyelectrolyte can comprise only positive charges and is free of negative charges.

The anionic polyelectrolyte and the cationic polyelectrolyte may be linear or branched polymers.

The cationic groups of the cationic polyelectrolyte can contain, for example, primary, secondary, or tertiary amino groups or quaternized amine groups, located in the main chain of the polymer or on side chains (if branched).

The anionic groups of the anionic polyelectrolyte are for example selected from the group consisting of carboxylate, sulphonate, phosphonate, boronate, sulphate, borate, and phosphate groups, located in the main chain of the polymer or on side chains (if branched).

In one aspect, non-limiting examples of the cationic polyelectrolyte can be selected from: polyethyleneimine, poly(diallyldimethylammonium chloride) (PDADMAC), poly[(2-hydroxypropyl)dimethylammonium chloride], polyamidoamine-epichlorhydrine (PAAE), poly(acrylamide-co-diallyldimethylammonium chloride), poly(acrylic acid-co-diallyldimethylammonium chloride), copolymer of hydroxyethylcellulose and poly(diallyldimethylammonium chloride) (Polyquaternium-4), copolymer of acrylamide and dimethylaminoethylmethacrylate quaternized with dimethyl sulphate (Polyquaternium-5, CAS 26006-22-4), copolymer of dimethylaminomethyl methacrylate and alkyl methacrylate, copolymer of methyl and stearyl dimethylaminoethyl ester of methacrylic acid, homopolymer of N,N-(dimethylamino)ethyl ester of methacrylic acid quaternized with bromomethane or quaternized hydroxyethyl cellulose, chitosan, poly(quaternized N,N-(dimethylamino)ethyl methacrylate), guar hydroxypropyltrimonium chloride, poly(2-(dimethylamino)ethyl methacrylate, poly(N,N-dimethyl-3,5-dimethylene piperidinium chloride), poly (vinylbenzyl trimethylammonium chloride), poly[3-(methacryloylamino)propyl-trimethylammonium chloride], ([2-(methacryloloxy)ethyl]-trimethylammonium chloride), polyvinylamine (PVA), poly(N,N-dimethyl-3,5-dimethylene piperidinium chloride) (PDDPC), poly(vinylbenzyltrimethyl ammonium chloride) (PVBTAC), poly(allylamine hydrochloride) (PAH), poly[3-(methacryloylamino)propyltrimethylammonium chloride](PMAPTAC), cationic dextran, poly(aniline), poly(2-vinylpyridine), poly(L-lysine), gelatin type A, or any combination thereof.

In a particular aspect, the cationic polyelectrolyte can be selected from polyethyleneimine, poly(allylamine hydrochloride), poly(aniline), poly(2-vinylpyridine), poly(2-(dimethylamino)ethyl methacrylate), poly(L-lysine), chitosan, or any combination thereof.

In another aspect, non-limiting examples of the anionic polyelectrolyte can include: poly(acrylic acid), poly(acrylic acid-co-acrylamido), poly(4-styrene-sulfonic acid), lignosulfonic acid, humic acid, alginic acid, poly(2-acrylamido-2-methyl-1-propanesulfonic acid), hyaluronic acid, poly(vinylsulfonic acid), poly(glutamic acid), dextran-sulfate, salts thereof (e.g. sodium salts), gelatin type B, or any combination thereof.

In a certain aspect, the anionic polyelectrolyte can include polyacrylic acid, poly(methacrylic acid), poly(glutamic acid), hyaluronic acid, alginic acid, salts thereof (e.g., sodium salts), or any combination thereof.

The weight average molecular weight (determined by light scattering) of each of the anionic and cationic polyelectrolytes can be between 5,000 and 2,000,000 Da, preferably between 10,000 and 1,500,000 Da, more preferably between 20,000 and 1,000,000 Da, even more preferably between 20,000 and 500,000 Da, for instance between 20,000 and 300,000 Da.

The ratio of the weight average molecular weight of the anionic polyelectrolyte to the weight average molecular weight of the cationic polyelectrolyte can be between 12 and 2. In another aspect this ratio can be or between 0.4 and 1.6, or between 0.7 and 1.3, or between 0.8 and 1.2.

In a certain embodiment, at least one of the anionic polyelectrolyte and the cationic polyelectrolyte can be a weak polyelectrolyte.

In one embodiment, the cationic polyelectrolyte can be a weak polyelectrolyte (preferably branched) and the anionic polyelectrolyte may be a strong polyelectrolyte. In such embodiment, it is of advantage that the pH of the composition is higher than the pI of the weak cationic polyelectrolyte. The pI of a weak cationic polyelectrolyte is usually higher than 7, for instance between 7.5 and 14.

In another embodiment, the anionic polyelectrolyte can be a weak polyelectrolyte and the cationic polyelectrolyte may be a strong polyelectrolyte. In such embodiment, the pH of the composition should be lower than the pI of the weak anionic polyelectrolyte. The pI of a weak anionic polyelectrolyte is usually lower than 7, for instance between 1 and 6.5.

In a particular embodiment, the cationic polyelectrolyte and the anionic polyelectrolyte can be both weak polyelectrolytes. In this embodiment, the pH of the composition may be adjusted according to:

$$pH > {pI}_{+} , or$$

$$pH < {pI}_{-} ,$$

wherein pI₊ refers to the pI of the weak cationic polyelectrolyte and pI₋ refers to the pI of the weak anionic polyelectrolyte, with pI₊>pI₋.

In a certain particular aspect, both the cationic polyelectrolyte and the anionic polyelectrolyte can be week polyelectrolytes, and the pH of the composition may be greater than the isoelectric point of the week cationic polyelectrolyte (pI−), such that: pH>pI₊.

In a certain particular aspect, the pH of the composition can be at least 10, or at least 10.5, or at least 11.0, or at least 11.5, while the pI₊ of the week cationic polyelectrolyte may lower than the pH of the composition. For example, the pI₊ can be between 8 and 10, and the pH of the composition can be greater than 10.

In a certain particular aspect, the composition of the present disclosure can comprise polyethyleneimine as a weak cationic polyelectrolyte and poly(acrylic acid) as a weak anionic polyelectrolyte.

The composition of the present disclosure can comprise a pH buffer. A pH buffer can be of specific advantage to control the coacervate state, especially when at least one of the cationic polyelectrolyte or the anionic polyelectrolyte is a weak polyelectrolyte, and thereby may avoid the need of adding a water-soluble mineral salt to the composition. In a certain aspect, by using weak cationic and anionic polyelectrolytes and regulating the pH of the composition that pH>pI+, the composition can be essentially free of added water-soluble mineral salt. As used herein, essentially free of added water-soluble mineral salt means that the composition does not contain more than 1 wt % of an added water-soluble mineral salt based on the total weight of the composition, or not more 0.5 wt %, or mot more than 0.1 wt %, or not more than 0.05 wt %.

In a certain aspect, the pH buffer can be a volatile pH buffer. As used herein, a “volatile” pH buffer refers to a pH buffer having a boiling point below 400° C., preferably below 260° C., more preferably below 100° C., even more preferably below 50° C.

Examples of volatile pH buffers can include, but are not limited to, 2-amino-2-methyl-1-propanol, formic acid, pyridine/formic acid, trimethylamine/formic acid, pyridine/acetic acid, trimethylamine/acetic acid, ammonia/formic acid, ammonia/acetic acid, trimethylamine/carbonate, ammonium bicarbonate, ammonium carbonate/ammonia, ammonium carbonate, ammonia, and N-ethylmorpholine/acetate.

In a particular certain aspect, the volatile pH buffer can be 2-amino-2-methyl-1-propanol.

The amount of the pH buffer in the composition can range from 0.1 to 5 wt %, preferably from 0.2 to 4 wt %, more preferably from 0.5 to 2.5 wt %, relative to the total weight of the composition.

In another embodiment, both the cationic polyelectrolyte and the anionic polyelectrolyte can be strong polyelectrolytes. In this embodiment, in order to avoid the forming a precipitates caused by the charge attractions between the two polyelectrolytes, the composition may further comprise a water-soluble mineral salt to form and control coacervates of the strong cationic polyelectrolyte and the strong anionic polyelectrolyte.

As used herein, “water-soluble” means having a solubility in distilled water at 20° C. of more than 100 g/L, preferably more than 200 g/L, even more preferably more than 300 g/L.

The water-soluble mineral salt can be selected from alkaline metal or alkaline earth metal halogenides. Preferred alkaline metal are lithium, sodium, and potassium. Preferred alkaline earth metal are calcium and magnesium. Preferred halogenides are chlorides and bromides. The function of the water-soluble mineral salt is to screen the opposite charges and to thereby reduce the ionic interaction between the polyelectrolytes, to prevent the formation of a solid insoluble polyelectrolyte complex and to allow the formation of a coacervate (a viscous polyelectrolyte-rich solution). The water-soluble mineral salt can be a monovalent metal salt, i.e., an alkaline metal halogenide.

The suitable amount of water-soluble mineral salt depends on the total amount of polyelectrolyte charges, i.e., for a given molecular weight of the polyelectrolytes, it is roughly proportional to the amount of polyelectrolytes in the composition. When present, the amount of water-soluble mineral salt is typically comprised between 40% and 95% by weight, preferably between 55% and 75% by weight, with respect to the total dry weight of cationic polyelectrolyte, anionic electrolyte, and water-soluble mineral salt. The weight ratio of the total amount of cationic polyelectrolyte and anionic polyelectrolyte to the total amount of water-soluble mineral salt (when present) can be between 0.10 and 4.0, or between 0.50 and 2.50, or between 0.80 and 1.50.

The amount of the cationic polyelectrolytes and anionic polyelectrolytes together in the composition of the present disclosure can be at least 1 wt % based on the total weight of the composition, or at 1.5 wt %, or at least 2 wt %, or at least 3 wt %, or at least 4 wt %, or at least 5 wt %, or at least 7 wt %, or at least 10 wt %, or at least 12 wt %, or at least 15 wt %. In another aspect, the amount of the cationic and anionic polyelectrolyte together may be not greater than 45 wt % based on the total weight of the composition, or not greater than 40 wt %, or not greater than 35 wt %, or not greater than 30 wt %, or not greater than 25 wt %, or not greater than 20 wt %, or not greater than 15 wt %, or not greater than 10 wt %, or not greater than 7 wt %, or not greater than 5 wt %, or not greater than 3 wt %. The amount of cationic and anionic polyelectrolyte can be a value within any of the maximum and minimum numbers listed above, such as between 1 wt % and 20 wt %, or between 1 wt % and 5 wt %.

The low glass transition temperature polymer (low Tg polymer) contained in the composition of the present disclosure may impart flexibility to a coating formed from the composition.

In one aspect, the glass transition temperature of the low Tg polymer can be lower than 30° C., such as lower than 20° C., lower than 10° C., lower than 0° C., lower than −10° C., lower than −20° C., lower than −30° C., or lower than −40° C. For instance, the Tg may be range from −70° C. to 50° C., from −60° C. to 30° C., from −50° C. to 10° C., or from −40° C. to 0° C.

The glass transition temperature (Tg) can be measured by differential scanning calorimetry (DSC).

The low Tg polymer may advantageously have a MFFT (minimum film-forming temperature) below 20° C., preferably below 10° C., more preferably below 0° C. The MFFT is determined according to the ASTM D 2354 and ISO 2115 standards. The MFFT is given here for atmospheric pressure (i.e., 1 bar).

Non-limiting examples of polymers having a low Tg can be acrylic polymers, methacrylic polymers, polyvinyl butyral, ethylene-vinyl acetate polymers, ethylene-vinyl chloride polymers, styrene-acrylic polymers, styrene-butadiene polymers, chloroprene, natural rubber, or any combination thereof.

The low Tg polymer may be a homopolymer or a copolymer. In a certain aspect, the low Tg polymer can be formed by polymerization including at least one of the following monomers in the reaction: 2-ethyl hexyl acrylate, butyl acrylate, ethyl acrylate, methyl acrylate, acrylic acid, hydroxyethyl methacrylate, styrene, cyclohexyl methacrylate, butyl methacrylate, isobornyl methacrylate, isobutyl methacrylate, ethyl methacrylate, isobornyl acrylate, methyl methacrylate, vinyl acetate, butadiene.

In a particular aspect, the low Tg polymer can be an acrylic acid ester copolymer having a glass transition temperature lower than −10° C.

The amount of the low Tg polymer can be at least 0.5 wt % based on the total weight of the composition, or at least 0.8 wt %, or at least 1.0 wt %, or at least 1.3 wt %, or at least 1.5 wt %, or at least 1.7 wt %, or at least 2 wt %, or at least 3 wt %. In another aspect the amount of the polymer having a low Tg may be not greater than 15 wt %, or not greater than 12 wt %, or not greater than 7 wt %, or not greater than 5 wt %, or not greater than 3 wt %, or not greater than 2 wt %. The amount of the low Tg polymer can be a value within any of the numbers listed above, such as from 0.5 wt % to 15 wt %, or from 1 wt % to 7 wt %.

The boron nitride (BN) particles contained in the composition of the present disclosure can be preferably hexagonal boron nitride (hBN) particles, wherein “hexagonal” indicates the crystalline form of boron nitride.

In one embodiment, the boron nitride particles can be in the form of platelets having an aspect ratio of at least 5.

In one aspect, the average particle size (D50) of the BN particles can be at least 1 micron, or at least 2 microns, or at least 3 microns, or at least 5 microns, or at least 10 microns, or at least 15 microns, or at least 20 microns, or at least 25 microns, or at least 30 microns. In another aspect, the D50 size of the BN particles may be not greater than 100 microns, or not greater than 50 microns, or not greater than 35 microns, or not greater than 30 microns, or not greater than 20 microns. The D50 size of the BN particles can be a value within any of the maximum and minimum numbers listed above, such as from 1 micron to 50 microns, or from 10 microns to 35 microns, or from 5 microns to 30 microns.

In another aspect, the aspect ratio of the BN particles can be at least 7, or at least 8, or at least 10, or at least 20, or at least 30, or at least 50, or at least 70, or at least 100. In a further aspect, the aspect ratio of the BN particles may be not greater than 200, or not greater than 150, or not greater than 100, or not greater than 60, or not greater than 40, or not greater than 30. The aspect ratio of the BN particles can be a value within any of maximum and minimum numbers listed above.

The D50 size of the BN particles can be determined by laser diffraction.

The boron-nitride particles can have a high purity, typically above 95 wt %, or even above 98 wt %, for instance above 99 wt %. In some embodiments, the boron-nitride particles may comprise impurities chosen from B₂O₃ and O₂, in a total amount of up to 5 wt %, preferably not greater than 2 wt %, more preferably not greater than 1 wt %.

The amount of boron-nitride particles in the composition of the present disclosure can be at least 55 wt % based on the dry weight of the composition, or at least 60 wt %, or at least 65 wt %, or at least 70 wt %, or at least 75 wt %, or at least 80 wt %, or at least 90 wt %. In another aspect, the amount of the BN particles may be not greater than 95 wt %, or not greater than 93 wt %, or not greater than 92 wt %, or not greater than 90 wt %, or not greater than 87 wt %, or not greater than 85 wt %. The amount of the BN particles can be a value within any of the maximum and minimum numbers listed above, such as from 57 wt % to 92 wt %, or from 60 wt % to 86 wt %, or from 64 wt % to 86 wt %.

In another aspect, the amount of BN particles based on the total weight of the composition (before removing the water) can be at least 20 wt % based on the total weight of the composition, or at least, 25 wt %, or at least 30 wt %, or at least 35 wt %, or at least 40 wt %, or at least 45 wt %, or at least 50 wt %, or at least 55 wt %. In a further aspect, the amount of BN may be not greater than 80 wt % based on the total weight of the composition, or not greater than 70 wt %, or not greater than 60 wt %.

The ratio of the weight of boron nitride particles to the combined weight of the cationic and the anionic polyelectrolytes based on the total dry weight of the composition can be at least 3 or at least 5, or at least 7, or at least 10, or at least 20, or at least 30, or at least 40, or at least 50.

In another aspect, the weight ratio of the weight of the BN particles to the combined weight of the cationic and anionic polyelectrolyte may be not greater than 100, or not greater than 80, or not greater than 60. The ratio can be a value within any of the maximum and minimum numbers listed above, such as from 3 to 70, or from 5 to 60, or from 30 to 55.

The composition can have a water content of at least 15 wt % based on the total weight of the composition, or at least 20 wt %, or at least 30 wt %, or at least 35 wt %, or at least 40 wt %, or at least 45 wt %, or at least 50 wt %, or at least 55 wt %. In another aspect the amount of water may be not greater than 80 wt % based on the total weight of the composition, or not greater than 75 wt %, or not greater than 60 wt %, or not greater than 60 wt %, or not greater than 50 wt %, or not greater than 45 wt %, or not greater than 40 wt %. The amount of the water in the composition can be any value within the maximum and minimum numbers listed above, such as from 15 wt % to 80 wt %, or from 25 wt % to 45 wt % based on the total weight of the composition.

The composition may further optionally comprise a water-soluble polyphenol comprising at least one polyhydroxylated aromatic ring structure. In one aspect, the water-soluble polyphenol can be in combination with a water-soluble polyvalent transition metal salt.

Moreover, the composition of the present disclosure may further comprise a tackifier. Examples of tackifiers include, but are not limited to, rosins esters, terpene oligomers, coumarone/indene resins, hydrocarbon resins (which are typically obtained by polymerization of terpenes, primarily α- or β-pinene, dipentene or limonene, optionally in combination with other monomers, for example styrene, α-methylstyrene, or isoprene), modified phenol resins, or terpenephenol resins (typically produced by acid-catalyzed addition of phenols onto terpenes or rosin). The amount of the tackifier can range from 0.02 wt % to 10% wt %, or from 0.05 to 5%, or from 0.1 to 2%, based on the total weight of the composition.

The composition may further comprise a particulate filler, herein also called “additional filler particles,” next to the boron nitride particles. As used herein, the term “particulate filler” does not include boron nitride particles to better distinguish the additional filler particles from the boron nitride particles.

The particulate filler may be a mineral filler, preferably a mineral filler selected from calcium carbonate, barium sulfate, clay, talcum, dolomite, mica, silica sand, crushed basalt, kaolin, wollastonite, laponite, any combination thereof.

In one aspect, the particulate filler may further improve the thermal conductivity of a coating formed from the composition. In one aspect, such a particulate filler can be alumina particles.

The amount of the particulate filler (not including BN particles) can be at least 1 wt %, or at least 5 wt %, or at least 10 wt %, or at least 20 wt % based on the dry weight of the composition.

In another aspect, the particulate filler may be not greater than 30 wt %, or not greater than 25 wt %, or not greater than 20 wt %, or not greater than 15 wt %, or not greater than 10 wt %, or not greater than 5 wt %, or not greater than 1 wt % based on the dry weight of the composition.

The average particle size (D50) of the particulate filler can range from 0.04 microns to 140 microns, preferably from 0.1 micron to 10 micron, or from 0.2 microns to 5 microns.

The composition may further comprise a hydrophobic agent, typically added as an emulsion. The hydrophobic agent may be a wax, for example paraffin wax, polyethylene wax, polypropylene wax, silicone wax and poly(tetrafluoroethylene) wax. Hydrophobic resins, for example hydrophobic silicone resins such as Variphob® AC 3030, may also efficiently be used as hydrophobic agents. The hydrophobic agent can be used in amounts up to 15 wt % based on the weight of the composition, and preferably between 3 wt % and 5 wt % by weight, with respect to the total dry weight of the composition.

The composition may comprise one or more further additives. Those additives can include, for example, cosolvents such as ethanol and polyethyleneglycol, dyes, pigments, biocides, surfactants, dispersants, thickening agents, antifoaming agents, or plasticizers.

The composition of the present disclosure may be in the form of a liquid or a paste, depending on the intended use.

In a certain aspect, the composition of the present disclosure can be a liquid having a viscosity at a temperature of 23° C. and a shear rate of 20 rpm of not greater than 2000 cP, or not greater than 1800 cP, or not greater than 1600 cP, or not greater than 1400 cP, or not greater than 1200 cP, or not greater than 1000 cP, or not greater than 800 cP, or not greater than 750 cP. In another certain aspect, the viscosity at 23° C. and a shear rate of 20 rpm may be at least 400 cP, or at least 500 cP or at least 600 cP, or at least 700 cP, or at least 800 cP, or at least 1000 cP.

In another embodiment, the present disclosure relates to a coating formed from the above-described composition and a process for manufacturing the coating.

The process can comprise the steps of: i) applying the above described composition of the present disclosure onto a substrate to form a wet coating, and ii) drying the wet coating to form a coating.

As used herein, if not indicated otherwise, the term “coating” always refers to the dry and solid state of the coating, after conducting drying of the wet coating. The term “wet coating” may be interchangeable used with the term “layer of the composition,” since the composition is applied in form of a wet coating layer on the substrate.

During the drying of the wet coating (composition), the polymers of the ingredients of the composition can react with each other, for example undergo cross-linking reactions, which may be regarded as a type of curing.

Applying the composition on the substrate can be carried out by any suitable method, in particular by using a roller, a brush or even by spraying. In one aspect, applying the composition can be carried out in several layers.

The substrate may be flexible or rigid. In one aspect, the substrate may be a plastic film (e.g., polyolefin-based films, such as polyethylene- and/or polypropylene-based films), a textile substrate, a paper substrate, a metal substrate, a ceramic substrate, or a foam (e.g., inorganic or organic foam) substrate.

In one aspect, drying of the wet coating may be an air-drying, with no heating. In another aspect, the wet coating may be dried by heating at a suitable temperature, for instance, a temperature between 50° C. and 180° C., more particularly between 80° C. and 120° C. The time needed for the drying may be adapted depending on the temperature of the drying. When no heating is applied, the drying may take several hours, for instance, 4 hours to 24 hours. When heating is applied, the drying may take a few minutes, for instance, 1 min to 20 min.

It may be advantageous to subject the wet coating to compression during the drying step. Such compression may further improve the thermal conductivity of the resulting “coating.” The compression may be applied during all or only a part of the drying. In one aspect, the compression may be applied toward the end of the drying step. In a particular aspect, the wet coating may be first partially dried without compression, and then further dried under compression.

The pressure of the compression may typically be up to 20 MPa, for instance, from 0.1 MPa to 20 MPa, particularly, from 1 MPa to 10 MPa, or from 1 MPa to 5 MPa.

The coating obtained by the process of the present disclosure can comprise a dense matrix of the ingredients of the composition, such as the cationic polyelectrolyte, the anionic polyelectrolyte, the boron nitride particles, and the low Tg polymer, and any further optionally added ingredients, except water and optionally added solvents or ingredients which may evaporate and be removed during the drying.

It is understood that the ratios described above for the composition when referred to “total dry weight of the composition” (e.g., the ratio of the weight of boron nitride particles to the total dry weight of cationic and anionic polyelectrolytes) applies to the coating as well, since the term “coating” relates to the composition after drying (i.e., dry coating).

The amount of boron nitride particles in the coating (i.e., dry coating) can range from 55 to 95 wt %, preferably from 60 to 90 wt %, more preferably from 60 to 85 wt %, based on the total weight of the coating.

The coating may have a thickness or at least 0.02 microns, or at least 0.05 microns, or at least 1 micron, or at least 2 microns, or at least 5 microns, or at least 10 microns, or at least 50 microns, or at least 100 microns, or at least 200 microns. In another aspect, the thickness of the coating may be not greater than 1000 microns, or not greater than 800 microns, or not greater than 600 microns, or not greater than 300 microns, or not greater than 100 microns. The thickness of the coating can be a value within any of the maximum and minimum numbers listed above, such as from 0.02 microns to 900 microns, or from 5 microns to 600 microns, or from 50 microns to 500 microns.

The thickness can be measured by optical measurements using for instance microscopy (e.g., scanning-electron microscopy “SEM”).

In one aspect, the coating can be easily removed from the substrate on which it was formed and integrated by itself in form of a sheet or film in an article containing a substrate. For example, the coating can be placed on top of an electronic board as the substrate.

In another aspect, an article can be formed by directly applying the composition of the present disclosure on a substrate, forming the coating, and maintaining the coating on the substrate.

In another aspect, the coating of the present disclosure can be a plurality of combined coatings layers in form of a stack, which can comprise at least 2 coating layers, or at least 5 layers, or at least 10 layers, or at least 20 layers, or at least 50 coating layers.

The coating may have an in-plane thermal conductivity of at least 1 W/mK, or at least 5 W/mK, or at least 10 W/mK, or at least 15 W/mK, or at least 18 W/mK, or at least 20 W/mK, or at least 25 W/mK, or at least 30 W/mK, or at least 34 W/mK. In another aspect, the thermal conductivity of the coating may be not greater than 100 W/mK, or not greater than 50 W/mK.

The thermal conductivity can be measured by using a transient plane source device, typically using a protocol as described in the examples.

The coating of the present disclosure is particularly suitable for being used in thermal applications. It may in particular be a coating for thermal management, such as a thermal interface material, a heater spreader, a thermal gap pad (e.g., thermal pad for a computer), a battery thermal runaway protection, an electric-vehicle battery dielectric coating (e.g. for insulation between cells and adjacent components, such as module housing and cooling plates or tubes), or a fire-resistant coating.

As further shown in the examples, it has been surprisingly observed that aqueous compositions with a high content of boron nitride particles can be formed, wherein the viscosity does not exceed 1500 cP at 20 rpm, which allow the forming of high quality and flexible coatings having a high thermal conductivity. Not being bound to theory, it is assumed that certain combinations of cationic and anionic polyelectrolytes can form coacervates which enable an even distribution of the BN particles within the composition without settling of particles and the maintaining of low viscosities. The compositions can be easily handled for forming coatings which can find use in thermal management applications.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### Embodiments

Embodiment 1. A composition comprising: a cationic polyelectrolyte; an anionic polyelectrolyte; boron nitride particles; a polymer having a glass transition temperature of lower than 50° C.; and water, wherein an amount of the boron nitride particles is at least 55 wt % based on a total dry weight of the composition.

Embodiment 2. The composition of Embodiment 1, wherein the boron nitride particles are hexagonal boron nitride (hBN) particles.

Embodiment 3. The composition of Embodiments 1 or 2, wherein the composition has a pH of at least 10.0, or at least 10.5, or at least 11.0.

Embodiment 4. The composition of Embodiment 3, wherein the pH is not greater than 13.8, or not greater than 13.5, or not greater than 13.0, or not greater than 12.5, or not greater than 12.0.

Embodiment 5. The composition of any one of the preceding Embodiments, wherein the composition is adapted of forming a coating, the coating having an in-plane thermal conductivity of at least 5 W/mK, or at least 10 W/mK, or at least 15 W/mK, or at least 18 W/mK, or at least 10 W/mK, or at least 25 W/mK, or at least 30 W/mK, or at least 34 W/mK.

Embodiment 6. The composition of Embodiment 5, wherein the coating layer has an in-plane thermal conductivity of not greater than 50 W/mK, or not greater than 45 W/mK, or not greater than 40 W/mK.

Embodiment 7. The composition of any one of the preceding Embodiments, wherein the glass transition temperature of the polymer is lower than 20° C., or lower than 0° C., or lower than −10° C., or lower than −20° C., or lower than −30° C., or lower than −40° C.

Embodiment 8. The composition according to Embodiment 7, wherein the polymer is selected from homopolymers or copolymers based on one or more of the following monomers: 2-ethyl hexyl acrylate, butyl acrylate, ethyl acrylate, methyl acrylate, acrylic acid, hydroxyethyl methacrylate, styrene, cyclohexyl methacrylate, butyl methacrylate, isobornyl methacrylate, isobutyl methacrylate, ethyl methacrylate, isobornyl acrylate, methyl methacrylate, vinyl acetate, butadiene.

Embodiment 9. The composition of Embodiment 8, wherein the polymer is an acrylic acid ester copolymer having a glass transition temperature lower than −10° C.

Embodiment 10. The composition of any one of the preceding Embodiments, wherein the cationic polyelectrolyte is a weak polyelectrolyte.

Embodiment 11. The composition according to Embodiment 10, wherein the pH of the composition (pHcomp) is higher than an isoelectric point of the weak cationic polyelectrolyte (pI₊), with pH_{comp}>pI₊.

Embodiment 12. The composition of any one of the preceding Embodiments, wherein the anionic polyelectrolyte is a weak polyelectrolyte.

Embodiment 13. The composition according to Embodiment 12, wherein a pH of the composition is lower than an isoelectric point of the weak anionic polyelectrolyte (pI−), with pH_{comp}<pI−.

Embodiment 14. The composition of any one of the preceding Embodiments, wherein the cationic polyelectrolyte and the anionic polyelectrolytes are both weak polyelectrolytes.

Embodiment 15. The composition of any one of the preceding Embodiments, wherein a ratio of a number of positive charges of the cationic polyelectrolyte to a number of negative charges of the anionic polyelectrolyte in the composition is between 0.5 and 2.0, or between 0.6 and 1.8, or between 0.7 and 1.6, or between 0.9 and 1.2.

Embodiment 16. The composition of any one of the preceding Embodiments, wherein an amount of the cationic polyelectrolyte and the anionic polyelectrolyte together ranges from 1% to 45 wt % based on the total weight of the composition, or from 1 to 20 wt %, or from 1 to 10 wt %, or from 1 to 5 wt %.

Embodiment 17. The composition of any one of the preceding Embodiments, wherein the cationic polyelectrolyte is selected from the group of: polyethyleneimine (PEI), poly(diallyldimethylammonium chloride) (PDADMAC), poly[(2-hydroxypropyl) dimethylammonium chloride], polyamidoamine-epichlorhydrine (PAAE), poly(acrylamide-co-diallyldimethylammonium chloride), poly(acrylic acid-co-diallyldimethylammonium chloride), copolymer of hydroxyethylcellulose and poly(diallyldimethylammonium chloride) (Polyquaternium-4), copolymer of acrylamide and dimethylaminoethylmethacrylate quaternized with dimethyl sulphate (Polyquaternium-5), copolymer of dimethylaminomethyle methacrylate and alkyl methacrylate, copolymer of methyl and stearyl dimethylaminoethyl ester of methacrylic acid, homopolymer of N,N-(dimethylamino)ethyl ester of methacrylic acid quaternized with bromomethane or quaternized hydroxyethyl cellulose, chitosan, poly(quaternized N,N-(dimethylamino)ethyl methacrylate), guar hydroxypropyltrimonium chloride, poly(2-(dimethylamino)ethyl methacrylate, poly(N,N-dimethyl-3,5-dimethylene piperidinium chloride), poly(vinylbenzyltrimethylammonium chloride), poly[3-(methacryloylamino)propyl-trimethylammonium chloride], poly([2-(methacryloloxy)ethyl]-trimethylammonium chloride), polyvinylamine (PVA), poly(N,N-dimethyl-3,5-dimethylene piperidinium chloride) (PDDPC), poly(vinylbenzyltrimethylammonium chloride) (PVBTAC), poly(allylamine hydrochloride) (PAH), poly[3-(methacryloylamino)propyltrimethylammonium chloride](PMAPTAC), cationic dextran, poly(aniline), poly(2-vinylpyridine), poly(L-lysine), gelatin type A, or any combination thereof.

Embodiment 18. The composition of Embodiment 17, wherein the cationic polyelectrolyte includes polyethyleneimine.

Embodiment 19. The composition of any one of the preceding Embodiments, wherein the anionic polyelectrolyte is selected from the group consisting of poly(acrylic acid), poly(acrylic acid-co-acrylamido), poly(4-styrene-sulfonic acid), lignosulfonic acid, humic acid, alginic acid, poly(2-acrylamido-2-methyl-1-propanesulfonic acid), hyaluronic acid, poly(vinylsulfonic acid), poly(glutamic acid), dextran-sulfate, gelatin type B, salts thereof, and any combination thereof.

Embodiment 20. The composition of Embodiment 19, wherein the anionic polyelectrolyte includes poly(acrylic acid).

Embodiment 21. The composition of any one of the preceding Embodiments, wherein the composition further comprises a pH buffer.

Embodiment 22. The composition of Embodiment 21, wherein the pH buffer is a volatile pH buffer.

Embodiment 23. The composition of Embodiments 20 or 21, wherein the volatile pH buffer is designed for adjusting a pH between 10 and 12.

Embodiment 24. The composition of any one of Embodiments 21 to 23, wherein the pH buffer includes 2-amino-2-methyl-1-propanol.

Embodiment 25. The composition of any one of the preceding Embodiments, wherein the boron nitride (BN) particles have an average (D50) particle size of at least 1 micron, or at least 2 microns, or at least 3 microns, or at least 5 microns, or at least 10 microns, or at least 15 microns, or at least 20 microns, or at least 25 microns, or at least 30 microns.

Embodiment 26. The composition of any one of the preceding Embodiments, wherein the BN particles have an average (D50) particles size of not greater than 100 microns, or not greater than 50 microns, or not greater than 40 microns, or not greater than 35 microns, or not greater than 30 microns, or not greater than 25 microns, or not greater than 20 microns.

Embodiment 27. The composition of any one of the preceding Embodiments, wherein the BN particles have a D50 particle size from 1 micron to 50 microns, or from 10 microns to 35 microns, or from 2 microns to 20 microns.

Embodiment 28. The composition of any one of the preceding Embodiments, wherein the amount of the BN particles is at least 60 wt % based on the total dry weight of the composition, or at least 65 wt %, or at least 70 wt %, or at least 75 wt %, or at least 80 wt %, or at least 85 wt %, or at least 90 wt %.

Embodiment 29. The composition of any one of the preceding Embodiments, wherein the amount of the BN particles is not greater than 93 wt % based on the total dry weight of the composition, or not greater than 92 wt %, or not greater than 90 wt %, or not greater than 86 wt %.

Embodiment 30. The composition of any one of the preceding Embodiments, wherein an aspect ratio of the BN particles is at least 5, or at least 7, or at least 10, or at least 20, or at least 30, or at least 40, or at least 50, or at least 70, or at least 100, or at least 120.

Embodiment 31. The composition of Embodiment 30, wherein the aspect ratio of the BN particles is not greater than 200, or not greater than 150, or not greater than 100, or not greater than 50, or not greater than 35, or not greater than 20.

Embodiment 32. The composition of any one of the preceding Embodiments, wherein a viscosity of the composition at 23° C. and at a shear rate of 20 rpm is not greater than 2000 cP, or not greater than 1800 cP, or not greater than 1600 cP, or not greater than 1400 cP, or not greater than 1200 cP, or not greater than 1000 cP, or not greater than 800 cP, or not greater than 750 cP.

Embodiment 33. The composition of Embodiment 32, wherein the viscosity of the composition at 23° C. and a shear rate of 20 rpm is at least 400 cP, or at least 500 cP or at least 600 cP, or at least 700 cP, or at least 800 cP, or at least 1000 cP.

Embodiment 34. The composition of any one of the preceding Embodiments, wherein the composition is adapted of forming a coating, the coating having a Shore A hardness of at least 5, or at least 8, or at least 10, or at least 15, or at least 20, or at least 25.

Embodiment 35. The composition of Embodiment 34, wherein the Shore A hardness is not greater than 60, or not greater than 50, or not greater than 40, or not greater than 35, or not greater than 30, or not greater than 25.

Embodiment 36. An article comprising a substrate and a coating overlying the substrate, wherein the coating is formed from the composition of any one of the preceding Embodiments.

Embodiment 37. The article of Embodiment 36, wherein an in-plane thermal conductivity of the coating is at least 5 W/mK, or at least 10 W/mK, or at least 15 W/mK, or at least 18 W/mK, or at least 20 W/mK, or at least 25 W/mK, or at least 30 W/mK, or at least 34 W/mK.

Embodiment 38. The article of Embodiments 36 or 37, wherein the coating is adapted for a thermal management of the article, such as a thermal interface material, a heater spreader, a thermal gap pad, a battery thermal runaway protection, an electric-vehicle battery dielectric coating, or a fire-resistant coating.

Embodiment 39. A process for manufacturing a coating comprising:
applying a composition onto an outer surface of a substrate to form a wet coating, the composition comprising a cationic polyelectrolyte, an anionic polyelectrolyte, boron nitride (BN) particles, a polymer having a glass transition temperature of lower than 50° C., and water; and drying the wet coating to form the coating, wherein the coating has an in-plane thermal conductivity of at least 5 W/mK.

Embodiment 40. The process of Embodiment 39, wherein drying is conducted at a temperature of at least 80° C.

Embodiment 41. The process according to Embodiments 39 or 40, wherein the wet coating is subjected to compression during the drying.

Embodiment 42. The process of any one of Embodiments 39 to 41, wherein the coating has an in-plane thermal conductivity of at least 10 W/mK, or at least 15 W/mK, or at least 18 W/mK, or at least 20 W/mK, or at least 25 W/mK, or at least 30 W/mK, or at least 34 W/mK.

Embodiment 43. The process of any one of Embodiments 39 to 42, wherein the amount of the BN particles in the coating is at least 60 wt % based on the total weight of the coating, or at least 65 wt %, or at least 70 wt %, or at least 75 wt %, or at least 80 wt %, or at least 85 wt %, or at least 90 wt %.

Embodiment 44. The process of any one of Embodiments 39 to 43, wherein the amount of the BN particles is not greater than 93 wt % based on the total weight of the coating, or not greater than 92 wt %, not greater than 90 wt %, or not greater than 86 wt %.

Embodiment 45. The process of any one of Embodiments 39 to 44, wherein an aspect ratio of the BN particles is at least 5, or at least 7, or at least 10, or at least 20, or at least 30, or at least 40, or at least 50, or at least 70, or at least 100, or at least 120.

Embodiment 46. The process of Embodiment 45, wherein the aspect ratio of the BN particles is not greater than 200, or not greater than 150, or not greater than 100, or not greater than 50, or not greater than 35, or not greater than 20, or not greater than 10.

Embodiment 47. The process of any one of Embodiments 39 to 47, wherein a viscosity of the composition at 23° C. and at a shear rate of 20 rpm is not greater than 2000 cP, or not greater than 1800 cP, or not greater than 1600 cP, or not greater than 1400 cP, or not greater than 1200 cP, or not greater than 1000 cP, or not greater than 800 cP, or not greater than 750 cP.

Embodiment 48. The process of Embodiment 47, wherein the viscosity of the composition at 23° C. and at a shear rate of 20 rpm is at least 400 cP, or at least 500 cP or at least 600 cP, or at least 700 cP, or at least 800 cP, or at least 1000 cP.

Embodiment 49. The process of any one of Embodiments 39 to 48, wherein the coating has a Shore A hardness of at least 5, or at least 8, or at least 10, or at least 15, or at least 20, or at least 25.

Embodiment 50. The process of Embodiment 49, wherein the coating has a Shore A hardness of not greater than 60, or not greater than 50, or not greater than 40, or not greater than 35, or not greater than 30, or not greater than 25.

Embodiment 51. The process of any one of Embodiments 39 to 50, wherein the cationic polyelectrolyte is a weak cationic polyelectrolyte and the anionic polyelectrolyte is a weal anionic polyelectrolyte.

Embodiment 52. The process of any one of Embodiments 39 to 51, wherein an isoelectric point of the cationic polyelectrolyte (pI₊) is lower than the pH of the composition.

Embodiment 53. The process of any one of Embodiments 39 to 52, wherein the composition has a pH of at least 10.0, or a pH of at least 10.5, or a pH of at least 11.0.

Embodiment 54. The process of any one of Embodiments 39 to 53, wherein the coating has a thickness of at least 0.02 microns, or at least 0.05 microns, or at least 1 micron, or at least 2 microns, or at least 5 microns, or at least 10 microns, or at least 50 microns, or at least 100 microns, or at least 200 microns.

Embodiment 55. The process of any one of Embodiments 39 to 54, wherein the coating has a thickness of not greater than 1000 microns, or not greater than 800 microns, or not greater than 600 microns, or not greater than 300 microns, or not greater than 100 microns.

Embodiment 56. The process of any one of Embodiments 39 to 55, wherein the coating has a thickness from 0.02 microns to 1000 microns, or from 2 microns to 600 microns, or from 5 microns to 500 microns.

### EXAMPLES

### Example 1

### Preparation of a Composition Comprising Weak Polyelectrolytes and Boron Nitride Particles.

Aqueous compositions were prepared (samples S1, S2, and S3) containing a polyethylene imine (PEI) with an average molecular weight (M_{w}) of about 25,000 as a weak cationic polyelectrolyte (from Sigma Aldrich, product code 408727); a polyacrylic acid with an average molecular weight (M_{w}) of 250,000 (from Sigma Aldrich, product code 416002) as a weak anionic polyelectrolyte; and varying amounts of hexagonal boron nitride (h-BN) particles having a D50 size of 30 microns and an aspect ratio of 30. The compositions further contained a polyacrylate polymer with a glass transition temperature of −46° C. (Alberdingk AC 75015 VP), and a pH buffer (AMP 95) to insure that the compositions had a pH between 10 and 12. After combining all ingredients mixing was conducted under stirring at 4000 rpm for 5 minutes. The final pH of compositions after the mixing was greater than 10, typically between 10.5 and 11.5. A summary of the exact compositions S, S2, and S3 is shown in Tables 1, 2, and 3 below.

TABLE 1
Composition S1

| | | | | Content in dry |
|---|---|---|---|---|
| | Weight | Content | | composition/ |
| | (g) | (wt %)* | | coating (wt %) |
| Water | 10 | 37 | | — |
| AMP 95 (buffer) | 0.45 | 1.7 | | — |
| Polyethyleneimine (25 wt | 2.8 (0.7) | 10.4 | (2.6) | 6.2 |
| % solids; 25 kg/mol) | | | | |
| Polyacrylic acid (35 wt | 1 (0.35) | 3.7 | (1.3) | 3.1 |
| % solids; 250 kg/mol) | | | | |
| h-BN particles | 6.9 | 26 | | 60.8 |
| Low Tg polyacrylate (60 | 5.25 (3.15) | 19.5 | (11.72) | 27.7 |
| wt % solids) | | | | |
| Deairator (Polyether | 0.28 | 1.0 | (0.25) | 0.5 |
| siloxane, 20 wt % solids) | | | | |

| | | | |
|---|---|---|---|
| Defoamer (BYK 018) | 0.2 | 0.7 | 1.7 |
| Total | 26.88 | 100 | 100 |

*based on the total weight of the composition

TABLE 2
Composition S2

| | | | | Content in dry |
|---|---|---|---|---|
| | Weight | | Content | composition/ |
| | (g) | | (wt %)* | coating (wt %) |
| Water | 24 | | 33.2 | — |
| AMP 95 (buffer) | 1 | | 1.4 | — |
| Polyethyleneimine (25 wt | 2.8 | (0.7) | 3.9 (1.0) | 1.7 |
| % solids; 25 kg/mol) | | | | |
| Polyacrylic acid (35 wt % | 1 | (0.35) | 1.4 (0.5) | 0.8 |
| solids; 250 kg/mol) | | | | |
| h-BN particles | 35 | | 48.4 | 84.9 |
| Low Tg polyacrylate (60 wt | 7 | (4.2) | 9.6 (5.8) | 10.2 |
| % solids) | | | | |
| Wetting agent (BYK 3410) | 0.4 | | 0.5 | 1.0 |
| Deairator (Polyether | 0.7 | | 1.0 (0.25) | 0.3 |
| siloxane, 20 wt % solids) | | | | |

| | | | |
|---|---|---|---|
| Defoamer (BYK 018) | 0.45 | 0.6 | 1.1 |
| Total | 72.35 | 100 | 100 |

*based on the total weight of the composition

TABLE 3
Composition S3

| | | | | Content in dry |
|---|---|---|---|---|
| | Weight | | Content | composition/ |
| | (g) | | (wt %)* | coating (wt %) |
| Water | 26 | | 27.27 | — |
| AMP 95 (buffer) | 1 | | 1.05 | — |
| Polyethyleneimine (25 wt | 2.8 | (0.7) | 2.94 (0.73) | 1.1 |
| % solids; 25 kg/mol) | | | | |
| Polyacrylic acid (35 wt % | 1 | (0.35) | 1.05 (0.36) | 0.56 |
| solids; 250 kg/mol) | | | | |
| h-BN particles | 56 | | 58.74 | 90 |
| Low Tg polyacrylate (60 wt | 7 | (4.2) | 7.3 (4.4) | 6.7 |
| % solids) | | | | |
| Wetting agent (BYK 3410) | 0.4 | | 0.42 | 0.64 |
| Deairator (Polyether | 0.7 | | 0.73 (0.15) | 0.22 |
| siloxane, 20 wt % solids) | | | | |

| | | | |
|---|---|---|---|
| Defoamer (BYK018) | 0.45 | 0.46 | 0.7 |
| Total | 95.35 | 100 | 100 |

*based on the total weight of the composition

### Measurement of the Isoelectric Point of the Polyelectrolytes:

The isoelectric point of the cationic and anionic polyelectrolytes of the compositions S1, S2, and S3 was determined according to the following procedure:

The Zeta Potential of the polyelectrolytes, either anionic or cationic, were measured using a Malvern Instruments Zetasizer Nano ZS (linked to charge density) for single polymer solutions (PAA or PEI) as a function of the pH. The polyelectrolyte solutions were prepared at a charged units concentration (moles of PAA or PEI per unit volume) of 0.01 M (around 0.01 wt %) in water at 0.1 M NaCl. The pH of every sample was adjusted using 0.1 M NaOH and/or 0.1 M HCl solutions. Experiments were performed over the pH range between 1 and 13. The isoelectric point was estimated as being the pH were the Z-potential reaches 0.

The isoelectric point for the polyacrylic acid (PAA) was 4.5, and the isoelectric point for the polyethyleneimine (PEI) was 9.5.

### Viscosities of the Compositions:

The viscosities of the compositions S1 and S2 representative to the present disclosure were measured with a RV Brookfield viscometer DV2T at 23° C. using spindle size #2 at varying shear rates (5 rpm, 10 rpm, and 20 rpm). As illustrated in FIG. 1 and Table 4, it can be seen that with increasing shear rate the viscosities decreased. It was impressive that with an hBN content of about 48.5 wt % in the aqueous composition (composition S2) the viscosity at a shear rate of 20 rpm was not greater than about 1160 cP.

When attempting to measure the viscosity of comparative sample C2, it was necessary to change the spindle size to number 5 in view of the much higher viscosity, and the measured viscosity converted to an about six times higher viscosity at an rpm of 20 in comparison to the viscosity of composition S2, having the same amount of hBN.

TABLE 4

| | Viscosity [cP] | | |
|---|---|---|---|
| Sample | 5 rpm | 10 rpm | 20 rpm |
| S1 (60 wt % hBN) | 1416 | 1062 | 727 |
| S2 (85 wt % hBN) | 2050 | 1516 | 1156 |
| C2 (85 wt % hBN) | 15420 | 8540 | 6150 |

### Forming of Coatings:

For the forming of a coating, the respective composition was cast on a plastic substrate to form a wet coating and initially dried at 100° C. for 2 minutes. Thereafter, a pressure of 5 MPa was applied on the initially dried coating using a carver press at 90° C. for 5 minutes. The obtained coatings (herein also called dried films) for all the compositions had a thickness of about 200 μm, a length of about 10 cm and a width of about 10 cm.

The coating obtained from composition S1 contained about 60 wt % of h-BN particles (see Table 1). The coating obtained from composition S2 contained about 85 wt % of h-BN particles (see Table 2), and the coating obtained from composition S3 contained about 90 wt % of h-BN particles (see Table 3).

### Variation of the pH:

A comparative composition C1 was prepared the same way as composition S2, except that no pH buffer was used for adjusting the pH between 10-12. The comparative composition C1 had a pH of 8. It was not possible to prepare a suitable coating film from this comparative composition since the composition partially solidified already during the mixing of the ingredients.

### Comparative Composition not Including a Low Tg Polymer:

A comparative composition C2 was prepared the same way as composition S2, but not including the acrylate polymer with the low glass transition temperature (Alberdingk AC 75015 VP). It was not possible to form a film from comparative composition C2 (as for composition S2) since composition C2 partially solidified already during the mixing.

### Example 2

### Evaluation of the Thermal Conductivity, Hardness, and Flexibility of the Coatings.

From the coatings (films) formed from the compositions of Example 1, the thermal conductivity and shore A hardness was measured, and the flexibility evaluated.

The thermal conductivities were measured using a transient plane source device (TPS 2500 S, Hot Disk Instruments). The instrument and measurement are designed by placing a temperature sensor between two samples of the test material, introducing a pulse of heat at the surface of the test sample, measuring the temperature change, and calculating based thereon the thermal conductivity. The temperature sensor was a Paton-insulated Hot Disk® sensor model 5501 (6.4 mm radius). The heat pulse was varied in the range of 60-150 mW for 3-15 seconds to make sure that the conductivity values stay constant independent of the pulse parameters. The measurements were conducted according to the Hot Disk Thermal Constants Analyser Instruction Manual (2015 Apr. 15) from Hot Disk®. For the measurements of the in-plane thermal conductivity was used the slab module. A summary of the test results is shown in Table 5.

TABLE 5

| | h-BN | Thermal | | |
|---|---|---|---|---|
| | Loading | Conductivity | Shore A | Flexibility |
| Sample | (wt %) | (W/mK) | Hardness | evaluation |
| S1 | 60 | 6.7 ± 0.02 | 10 | 5 |
| S2 | 85 | 20.52 ± 0.07 | 25 | 4 |
| S2 | 90 | 34.82 ± 0.31 | being measured | 4 |
| C1 | 85 | 17 ± 0.03 | 80 | 1 |
| C2 | 85 | N/A | N/A | N/A |

The Shore A hardness of the coatings was measured according to ASTM D2240. To obtain the required thickness of the testing material as required by the ASTM, a stack of multiple coatings was formed until the thickness of about 6.4 mm was reached.

It can be seen from the data in Table 5 that the Shore A hardness increased with increasing hBN content and with increasing thermal conductivity. A large increase of the hardness was observed between sample S2 and comparative sample C1 from 25 to 80, which corresponded to a loss of the flexibility of the coating. Not being bound to theory, it is assumed that the loss in flexibility and large increase in the hardness was caused by not including an organic polymer with low glass transition temperature to the coating composition.

The flexibility of the coatings was visually evaluated by placing the coating (film) after the drying at its center over a pencil, and observing if the film bends without cracking. The flexibility was evaluated by giving points from 1 to 5, wherein 5 means that the film bends easily by itself without causing any cracking, 4 means that the film bends not by itself but by applying a minor pressure with the hand, without cracking, 3 means that the film bends by additional pressure with minor observable cracks, 2 means that the film bends with additional help and larger observable cracks, and 1 means that the film does not bends by itself, and the film brakes completely apart if bending is attempted under applied pressure by hand.

The examples showed that high concentrations of boron nitride particles could be introduced in the compositions, which allowed to form coatings which were still flexible after drying. The composition S1, S2, and S3 were homogeneous and stable, no settling of particles or phase separation was visually observed after one month. The data of Table 5 show that coatings could be formed from the compositions up to an hBN content of 90 wt %. The coatings formed from compositions S1, S2, and S3 had good mechanical strength and flexibility, and achieved surprisingly high thermal of conductivities at hBN contents of 85 wt % and 90 wt %.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

1. A composition comprising:
a cationic polyelectrolyte;
an anionic polyelectrolyte;
boron nitride particles;
a polymer having a glass transition temperature of lower than 50° C.; and
water,
wherein an amount of the boron nitride particles is at least 55 wt % based on a total dry weight of the composition.

2. The composition of claim 1, wherein the composition has a pH of at least 10.0.

3. The composition of claim 1, wherein a viscosity of the composition at 23° C. and at a shear rate of 20 rpm is not greater than 2000 cP.

4. The composition of claim 3, wherein the composition comprises at least 80 wt % boron nitride particles based on a total dry weight of the composition.

5. The composition of claim 4, wherein the composition is adapted of forming a coating having an in-plane thermal conductivity of at least 20 W/mK.

6. The composition of claim 1, wherein the glass transition temperature of the polymer is lower than 0° C.

7. The composition of claim 1, wherein the cationic polyelectrolyte is a weak polyelectrolyte and the anionic polyelectrolyte is a weak polyelectrolyte.

8. The composition according to claim 7, wherein the pH of the composition (pHcomp) is higher than an isoelectric point of the weak cationic polyelectrolyte (pI₊), with pHcomp>pI₊.

9. The composition of claim 7, wherein the weak cationic polyelectrolyte includes polyethyleneimine.

10. The composition of claim 7, wherein the weak anionic polyelectrolyte includes poly(acrylic acid).

11. The composition of claim 1, wherein the composition further comprises a volatile pH buffer.

12. The composition of claim 11, wherein the volatile pH buffer includes 2-amino-2-methyl-1-propanol.

13. The composition of claim 1, wherein the boron nitride (BN) particles have an average (D50) particle size of at least 1 micron and not greater than 100 microns.

14. The composition of claim 1, wherein an aspect ratio of the BN particles is at least 5.

15. The composition of claim 1, wherein the composition is adapted of forming a coating, the coating having a Shore A hardness of at least 5 and not greater than 50.

16. An article comprising a substrate and a coating overlying the substrate, wherein the coating is formed from the composition of claim 1.

17. A process for manufacturing a coating comprising:
applying a composition onto an outer surface of a substrate to form a wet coating, the composition comprising a cationic polyelectrolyte, an anionic polyelectrolyte, boron nitride (BN) particles in an amount of at least 55 wt % based on a total dry weight of the composition, a polymer having a glass transition temperature of lower than 50° C., and water; and
drying the wet coating to form the coating.

18. The process of claim 17, wherein the wet coating is further subjected to compression during the drying.

19. The process of claim 17, wherein the coating has a Shore A hardness of at least 5 and not greater than 60.

20. The process of claim 17, wherein an amount of the BN particles is at least 80 wt % based on the total weight of the coating, and the coating has an in-plane thermal conductivity of at least 20 W/mK.
